(19) United States
(12) Patent Application Publication
(10) Pub. No.: US 2008/0016781 A1
(43) Pub. Date: Jan. 24, 2008

(54) Connecting assembly for pushing outward window frame

(76) Inventor: Kuan-Chin Chung, Pingtung Hsien (TW)

Correspondence Address: KUAN-CHIN CHUNG, 235 Chung-Ho, Box 8-24, Taipei, omitted

(21) Appl. No.: 11/490,284

(22) Filed: Jul. 21, 2006

(51) Int. Cl. E05F 11/24

(52) U.S. Cl. 49/445; 49/339

(57) ABSTRACT

A connecting assembly for a pushing outward window frame comprises a frame substrate fixed to an outer frame of a window; a window substrate fixed to an upper and a lower window frame; a first driven unit and a second driven unit connected between the frame substrate and the window substrate; a pivotal unit connected at a pivotal portion of the first driven unit and the window substrate and having a supporting block; a first protrusion and a second protrusion installed on the frame substrate; the first protrusion being formed with a second pivotal hole; one end of the first driven unit being positioned to the frame substrate; the second protrusion having a pivotal hole; one end of the second driven unit being pivotally connected to the frame substrate; and the first protrusion having a first pivotal hole aside the second pivotal hole for installing a limiting block.

### FIELD OF THE INVENTION

The present invention relates to window parts, and in particular to connecting assembly for a pushing outward window frame, wherein the structure is simple and firm. One limiting block is used for opening and closing operations so as to save the cost in parts and in assembly. The limiting block has the effects of supporting and enhancing the first protrusion. The enlarged block at the lower side of the pivotal joint and at the connection of the first driven unit and the window substrate can support the weight of the window. Furthermore, bottoms of the pivotal joints can support and enhancing the first protrusion and second protrusion.

### BACKGROUND OF THE INVENTION

In the prior art, the connecting assembly for a pushing outward window frame has two types.

One has five linkages with tracks. Many parts are necessary and the assembly work is tedious and labor-consumed. Furthermore, the tracks are easy to be polluted so that the operation is not smooth. A great labor is necessary in closing and opening.

In another kind, four linkages are used, which are a retaining rod at the outer frame of a window, a window retaining rod of a window, and stop rod and a linkage rod connected between the outer frame and the retaining frame so as to form as a folded arm. The four rods are connected as on a plane which easily deform.

Furthermore, the retaining rod is added with a slide portion and a limiting portion. The assembly work is tedious and time consumed. Furthermore, the added part increases the cost and weakens the structure. It is uneconomic and is not firm and not practical.

### SUMMARY OF THE INVENTION

Accordingly, the primary object of the present invention is to provide a connecting assembly for a pushing outward window frame, wherein the structure is simple and firm. One limiting block is used for opening and closing operations so as to save the cost in parts and in assembly. The limiting block has the effects of supporting and enhancing the first protrusion. The enlarged block at the lower side of the pivotal joint at the connection of the first driven unit and the window substrate can support the weight of the window. Furthermore, bottoms of the pivotal joints can support and enhancing the first protrusion and second protrusion.

To achieve above objects, the present invention provides a connecting assembly for a pushing outward window frame which comprises a frame substrate fixed to an outer frame of a window; a window substrate is fixed to an upper and a lower window frame; a first driven unit and a second driven unit connected between the frame substrate and the window substrate; a pivotal unit connected at a pivotal portion of the first driven unit and the window substrate and having a supporting block at a lower end thereof; a first protrusion and a second protrusion installed on the frame substrate; the first protrusion being formed with a second pivotal hole; one end of the first driven unit being positioned to the frame substrate by using a pivotal joint to pass through the pivotal hole of the first protrusion and a hole in the first driven unit; the second protrusion having a pivotal hole; one end of the second driven unit of the second driven unit being pivotally connected to the frame substrate by using a pivotal joint; and the first protrusion having a first pivotal hole aside the second pivotal hole for installing a limiting block which is used to limit the first driven unit to a full open limiting position and limiting the second driven unit to a close limiting position.

The various objects and advantages of the present invention will be more readily understood from the following detailed description when read in conjunction with the appended drawing.

### BRIEF DESCRIPTION OF THE DRAWINGS

FIG. 1 is an assembled schematic view of the present invention.

FIG. 2 is a schematic view showing the operation of the present invention.

FIG. 3 is an elevational view of the present invention.

FIG. 4 is a schematic view of the present invention which is assembled.

FIG. 5 shows the frame substrate of the present invention.

FIG. 6 shows the first driven unit of the present invention.

FIG. 7 is a cross sectional view along line 7-7 of FIG. 4.

FIG. 8 is a cross sectional view along line 8-8 of FIG. 4.

FIG. 9 is a cross sectional view along line 9-9 of FIG. 4.

FIG. 10 is a cross sectional view along line 10-10 of FIG. 4.

FIG. 11 is a cross sectional view along line 11-11 of FIG. 4.

FIG. 12 shows the second driven unit of the present invention.

FIG. 13 shows the window substrate of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

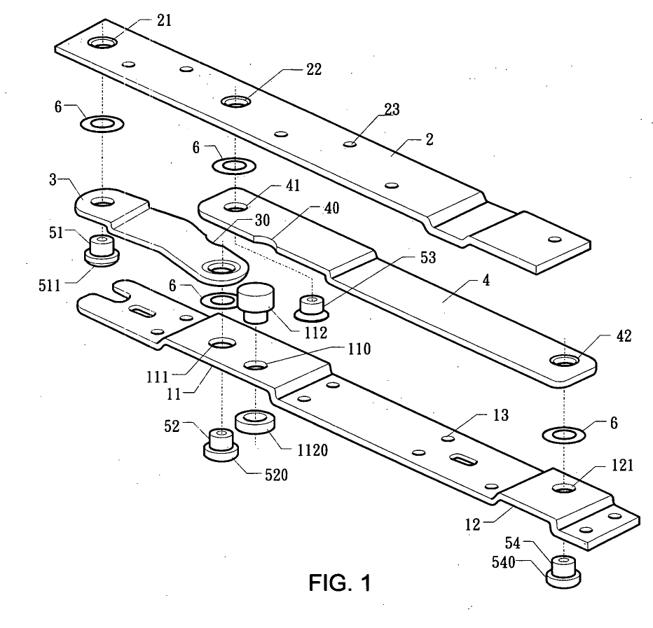

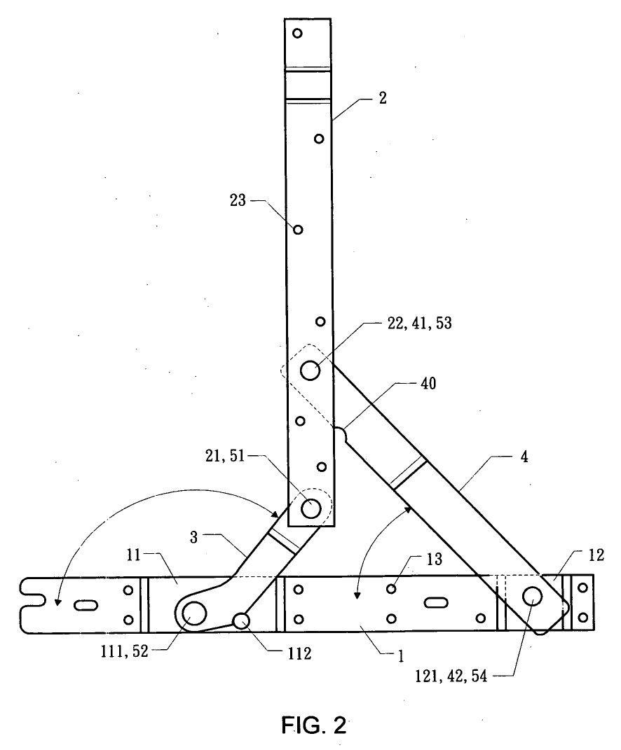

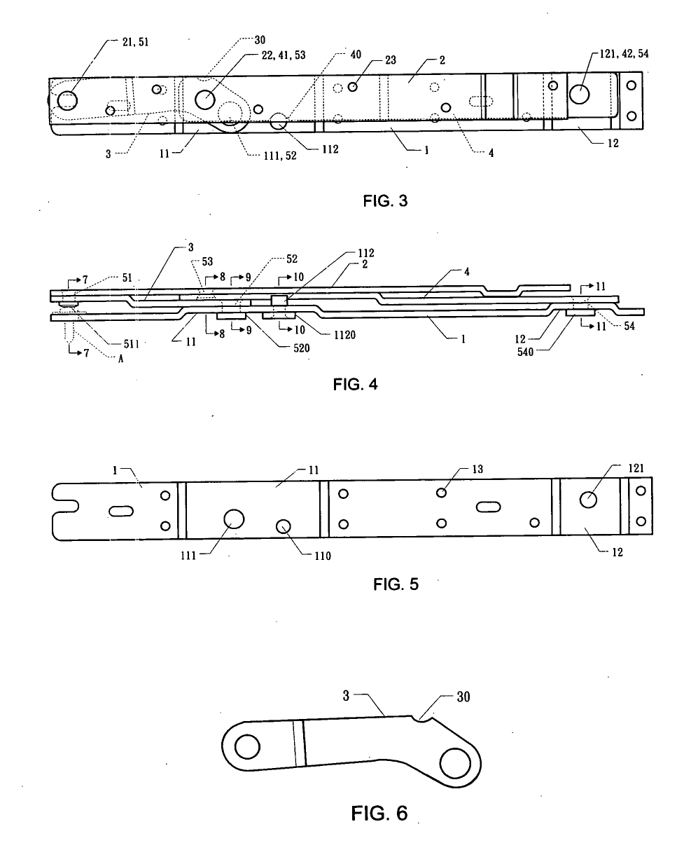

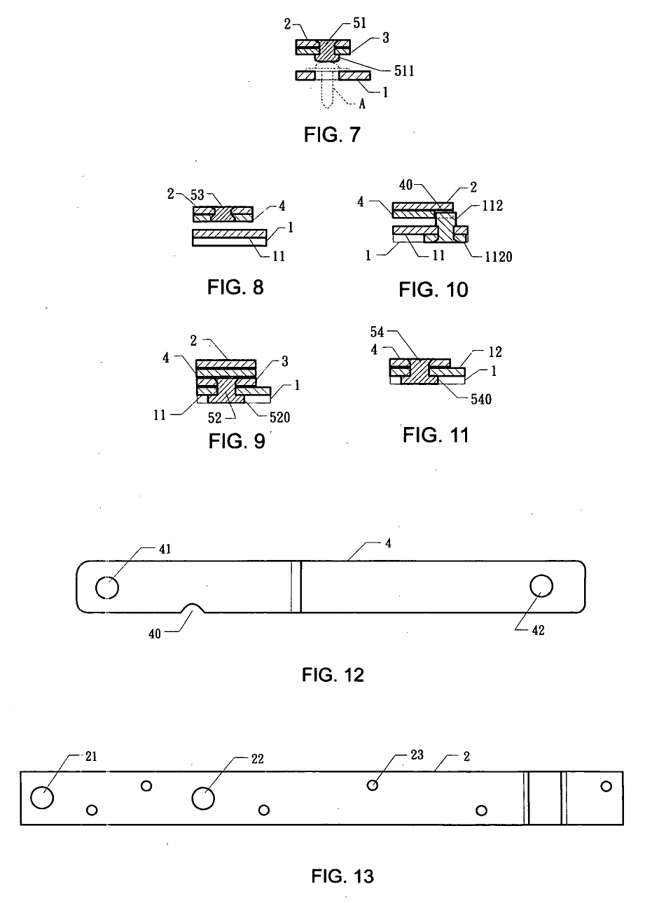

Referring to FIGS. 1 to 4, the structure of the present invention is illustrated. The present invention has the following elements.

A frame substrate 1 is fixed to an outer frame of a window.

A window substrate 2 is fixed to an upper and a lower window frame.

A first driven unit 3 and a second driven unit 4 are connected between the frame substrate 1 and the window substrate 2.

A pivotal unit 51 is connected at a pivotal portion of the first driven unit 3 and the window substrate 2 and has a supporting block 511 at a lower end thereof.

Referring to FIG. 5, a first protrusion 11 and a second protrusion 12 are installed on the frame substrate 1. The frame substrate 1 is formed with a plurality of retaining holes 13. The first protrusion 11 is formed with a second pivotal hole 111. One end of the first driven unit 3 is positioned to the frame substrate 1 by using a pivotal joint 52 to pass through the pivotal hole 111 of the first protrusion 11 and a hole in the first driven unit 3. The second protrusion 12 has a pivotal hole 121. One end of the second driven unit 4 is pivotally connected to the frame substrate 1 by using a pivotal joint 54.

The first protrusion 11 has a first pivotal hole 110 aside the second pivotal hole 111 for installing a limiting block 112 which is used to limit the first driven unit 3 to a full open limiting position and limiting the second driven unit 4 to a close limiting position. Referring to FIG. 10, the limiting block 112 has a large upper portion and a small lower portion. The large upper portion serves for limiting an elevation as the second driven unit 4 closes. The small lower portion of the limiting block 112 passes through the first pivotal hole 110 of the first protrusion 11 to engage to a ring 1120 so that a lower side of the ring 1120 is flushed with a lower side of the small lower portion so as to support and enhance the first protrusion 11.

Referring to FIG. 13, the window substrate 2 has a first pivotal hole 21 and a second pivotal hole 22 and a plurality of retaining holes 23. The first pivotal hole 21 is used to pivotally connect another end of the first driven unit 3 by using a pivotal joint 51. The second pivotal hole 22 serves to pivotally connect with another end of the second driven unit 4 by using a pivotal joint 53.

Referring to FIG. 6, the first driven unit 3 is a two staged plate. Two ends thereof have respective pivotal holes for passing through the pivotal join 51 and 52. A lateral side of the first driven unit 3 has a notch 30 for resisting the limiting block 112 as the first driven unit 3 is full open.

Referring to FIG. 12, the second driven unit 4 is a two staged plate. Two ends thereof have respective pivotal holes 41, 42 for receiving the pivotal joints 53 and 54. A lateral side of the second driven unit 4 has a notch 40 for resisting the limiting block 112 as the second driven unit 4 closes.

A bottom of the pivotal joint 51 has an enlarged portion 511. A bottom of each of the pivotal joints 52, 54 has an enlarged portion 520, 540. The heights of the enlarged portions 520, 540 are equal to a staged elevation 1 difference between the first protrusion 11 and the frame substrate 1 and the staged elevational difference between the second protrusion 12 and the frame substrate 1, respectively so as to support and enhance the first protrusion 11 and the second protrusion 12. A bottom of the pivotal joint 53 is a round tapered portion. The pivotal hole 41 of the second driven unit 4 has a shape corresponding to the round tapered portion of the pivotal joint 53 for stably and fully receiving the round tapered portion of the pivotal joint 53 not to interfere the operation thereof. The pivotal joints 51, 52, 53 and 54 are installed with washers 6.

Advantages of the present invention will be described herein. The structure is simple and firm. One limiting block is used for opening and closing operations so as to save the cost in parts and in assembly. The limiting block has the effects of supporting and enhancing the first protrusion. The enlarged block at the lower side of the pivotal joint at the connection of the first driven unit and the window substrate can support the weight of the window. Furthermore, bottoms of the pivotal joints 52, 54 can support and enhancing the first protrusion and second protrusion.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A connecting assembly for a pushing outward window frame, comprising:
a frame substrate (1) fixed to an outer frame of a window;
a window substrate (2) fixed to an upper and a lower window frame;
a first driven unit (3) and a second driven unit (4) connected between the frame substrate (1) and the window substrate (2); a pivotal unit (51) connected at a pivotal portion of the first driven unit (3) and the window substrate (2) and having a supporting block (511) at a lower end thereof;
a first protrusion (11) and a second protrusion (12) installed on the frame substrate (1); the first protrusion (11) being formed with a second pivotal hole (111); one end of the first driven unit (3) being positioned to the frame substrate (1) by using a pivotal joint (52) to pass through the pivotal hole (111) of the first protrusion (11) and a hole in the first driven unit (3); the second protrusion (12) having a pivotal hole (121); one end of the second driven unit (4) being pivotally connected to the frame substrate (1) by using a pivotal joint (54); and
the first protrusion (11) having a first pivotal hole (110) aside the second pivotal hole (111) for installing a limiting block (112) which is used to limit the first driven unit (3) to a full open limiting position and limiting the second driven unit (4) to a close limiting position.

2. The connecting assembly for a pushing outward window frame as claimed in claim 1, wherein the first driven unit (3) is a two staged plate; two ends thereof have respective pivotal holes for passing through the pivotal join (51) and (52) and the second driven unit (4) is a two staged plate; two ends thereof have respective pivotal holes (41, 42) for receiving the pivotal joints (53) and (54).

3. The connecting assembly for a pushing outward window frame as claimed in claim 1, wherein the limiting block ( 112) has a large upper portion and a small lower portion and the large upper portion serves for limiting an elevation as the second driven unit (4) closes.

4. The connecting assembly for a pushing outward window frame as claimed in claim 1, wherein the small lower portion of the limiting block (112) passes through the first pivotal hole (110) of the first protrusion (11) to engage to a ring (1120) so that a lower side of the ring (1120) is flushed with a lower side of the small lower portion so as to support and enhance the first protrusion (11).

5. The connecting assembly for a pushing outward window frame as claimed in claim 1, wherein the window substrate (2) has a first pivotal hole (21) and a second pivotal hole (22) and a plurality of retaining holes (23); the first pivotal hole (21) is used to pivotally connect another end of the first driven unit (3) by using a pivotal joint (51); and the second pivotal hole (22) serves to pivotally connect with another end of the second driven unit (4) by using a pivotal joint (53).

6. The connecting assembly for a pushing outward window frame as claimed in claim 1, wherein a lateral side of the first driven unit (3) has a notch (30) for resisting the limiting block (112) as the first driven unit (3) is full open.

7. The connecting assembly for a pushing outward window frame as claimed in claim 1, wherein a lateral side of the second driven unit (4) has a notch (40) for resisting the limiting block (112) as the second driven unit (4) closes.

8. The connecting assembly for a pushing outward window frame as claimed in claim 1, wherein a bottom of the pivotal joint (51) has an enlarged portion (511).

9. The connecting assembly for a pushing outward window frame as claimed in claim 1, wherein a bottom of each of the pivotal joint (52, 54) has an enlarged portion (520, 540); heights of the enlarged portions (520, 540) are equal to a staged elevation 1 difference between the first protrusion (11) and the frame substrate (1) and another staged elevational difference between the second protrusion (12) and the frame substrate (1), respectively, so as to support and enhance the first protrusion (11) and the second protrusion (12).

10. The connecting assembly for a pushing outward window frame as claimed in claim 1, wherein a bottom of the pivotal joint (53) is a round tapered portion; the pivotal hole (41) of the second driven unit (4) has a shape corresponding to the round tapered portion of the pivotal joint (53) for stably and fully receiving the round tapered portion of the pivotal joint (53) not to interfere the operation thereof; the pivotal joints (51), (52), (53) and (54) are installed with washers (6).
